(19) United States
(12) Patent Application Publication
(10) Pub. No.: US 2011/0107414 A1
(43) Pub. Date: May 5, 2011

(54) System and Method for Location Assisted Virtual Private Networks

(75) Inventors: Wael William Diab, San Francisco, CA (US); Jeyhan Karaoguz, Irvine, CA (US)

(73) Assignee: Broadcom Corporation, Irvine, CA (US)

(21) Appl. No.: 12/611,203

(22) Filed: Nov. 3, 2009

(51) Int. Cl. G06F 21/00

(52) U.S. Cl. 726/15

(57) ABSTRACT

A system and method for location assisted virtual private networks (VPNs). Users can create location uncertainty by logging into a VPN server that geographically remote from the present location. Geographic information provided by a VPN client along with or in combination with identification information can be used to resolve such location uncertainty. An accurate indication of the location of a VPN client can be used for operations, administration, maintenance, and provisioning purposes.

### BACKGROUND

1. Field of the Invention

The present invention relates generally to virtual private networks and, more particularly, to a system and method for location assisted virtual private networks.

2. Introduction

Virtual Private Networks (VPNs) have been used extensively in an enterprise context to facilitate access to various corporate resources. For example, employees can long in to the corporate network from home or on the road (e.g., using Wi-Fi Internet access) and have the same access to internal corporate IT resources (e.g., programs, emails, databases, printers, etc.) as they would if they were logging in from their on-campus office via the VPN capability.

VPNs enable users to access those internal corporate IT resources in a secure fashion using the routing infrastructure provided by a public network such as the Internet. VPNs not only facilitate a user's remote connection to the office, but also allows a corporation to connect IT resources at various branch locations over a public network. In providing secure communication over public networks, VPNs greatly lower the costs needed to duplicate such functionality by obviating the need for costly solutions such as dedicated leased lines. Although VPNs route traffic over public networks, the secure connection appears to the user as a communication over a private network. VPNs can extend the private network over the public (e.g., Internet) or other private (e.g., hotel) network resources on which it runs.

In maintaining security, only authenticated users can access the IT resources on the VPN. VPN communication is facilitated by VPN software on both the client and the server. For communication on the Internet, the VPN client software would communicate with the VPN corporate server software, whereupon the VPN server would authenticate the client. If the client is authenticated, then access to the IT resources on the VPN is granted by the VPN server.

While the connectivity benefits of VPNs are substantial, VPNs do create their own management issues as clients at virtual locations are scattered throughout the corporate network. What is needed therefore is a mechanism that enables an IT manager to properly locate and manage VPN clients.

### SUMMARY

A system and/or method for location assisted virtual private networks, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of a virtual private network.

FIG. 2 illustrates an example of a virtual private network client logging into a virtual private network.

FIG. 3 illustrates an example of a location assisted virtual private network.

FIG. 4 illustrates a flowchart of a process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

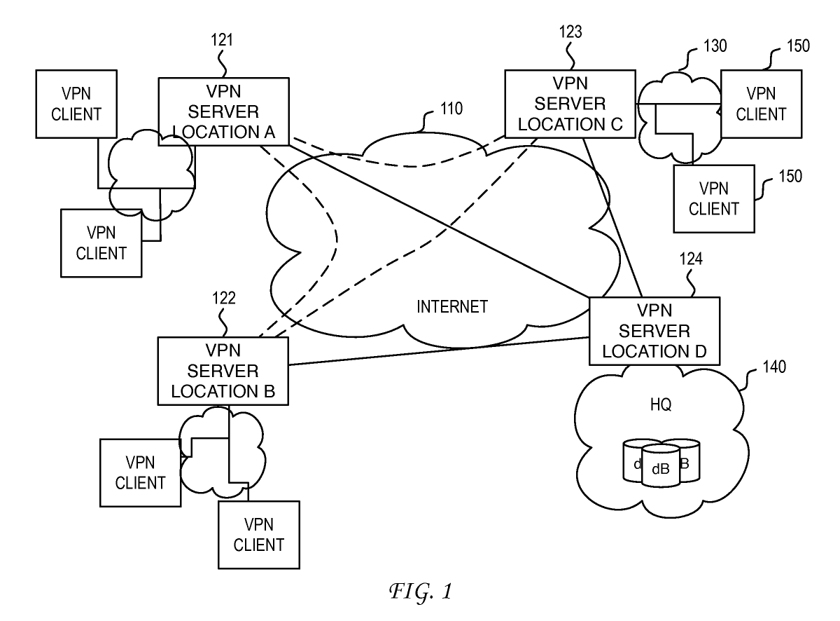

FIG. 1 illustrates an example network configuration that is facilitated by a VPN. As illustrated, an enterprise network can include multiple locations 121-124 that each host one or more VPN servers. Specifically, Location A hosts VPN server 121, Location B hosts VPN server 122, Location C hosts VPN server 123, and Location D hosts VPN server 124. In this illustrated example, Location D is designated as a headquarters (HQ) location, which hosts various corporate assets 140 (e.g., databases, servers, printers, etc.) that can be accessed from the remote Locations A-C.

Each of Locations A-D can be coupled via VPN links that are carried over a public network 110 such as the Internet. In one example, each of VPN servers 121-123 at Locations A-C are coupled directly to one or more VPN servers 124 at the HQ Location D. These individual connections would enable virtual connections amongst VPN servers 121-123 at Locations A-C.

As FIG. 1 further illustrates, each VPN server can support a plurality of VPN clients. For example, VPN server 123 at Location C supports VPN clients 150. VPN clients 150 are connected to VPN server 123 via a network link 130. As would be appreciated, a connection by a VPN client to a VPN server can be embodied in various forms. For example, consider the connection of VPN clients 150 to VPN server 123. These connections can be facilitated by network resource 130. Network resource 130 can include a dial-up connection over the telephony network, a wireless mobile connection over a cellular or satellite network, a Wi-Fi connection at a publicly accessible access point (e.g., airport, coffee shop, or the like), a broadband home network connection (e.g., cable, DSL, fiber optic, or the like), or any other link that supports a network data connection. In general, network resource 130 can represent a combination of public and private that facilitate access to VPN server 123. For example, VPN client 150 can access VPN server 123 via a private network (e.g., home, hotel, or the like) and a public network such as the Internet. Regardless of the type of resources embodied within network resource 130, an authenticated user that logs into VPN server 123 can then access all of the resources facilitated by the VPN.

In one embodiment, a user that seeks to log into a corporate VPN can select a particular one of a plurality of VPN servers at a respective plurality of locations to log into. For example, assume that a corporate VPN includes VPN servers in Los Angeles, San Francisco, Chicago, New York, Washington, D.C., London, and Seoul. Conventionally, a user can choose to log into any VPN server world wide, regardless of their current physical location. For example, if the user is in San Francisco, the user could choose to log into the Seoul VPN.

Once the user has logged into a particular VPN server, the user's identified location is then associated with that VPN server location. For example, once a user has logged into a VPN server, the user can be assigned an IP address that is associated with that VPN server. In another example, an indicator of a location can be associated with a database record associated with that user. Whether through the assigned IP address or an indicator of a location that is at least temporarily associated with a user, the location of the VPN server can provide a proxy for the location of the user. This location information that is derived from the VPN login process is useful by an enterprise's attempt to manage corporate assets worldwide. Moreover, to the outside world, it would appear that the user is at the physical location of the VPN server in which the user has logged in. Hence, websites such as Google or Yahoo would offer a Korean web page to a user logged into the Seoul VPN server, regardless of the actual physical location of the user.

As noted, the correspondence between a user's present physical location and the VPN server chosen during login is largely a choice by the user. Typically, while there may be a choice in terms of local speed to the connection, there is no significant restriction upon a user in a selection of a VPN server in a locale that is remote from the user's present location. For example, a user that is visiting Chicago can choose to login to a VPN server in London.

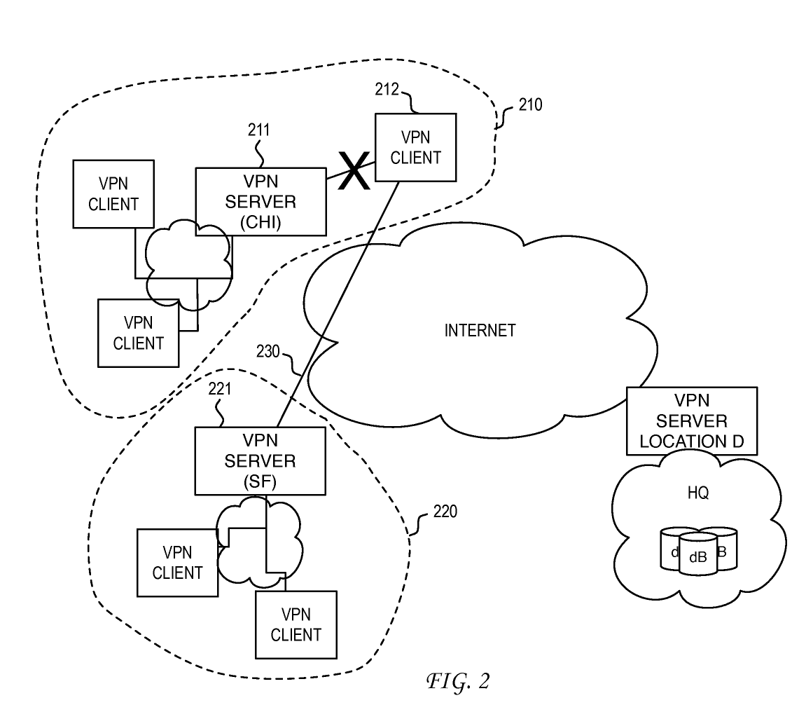

FIG. 2 illustrates an example of such a login process. As illustrated, VPN client 212 is visiting the Chicago region 210. Region 210 can represent any geographical region of interest (e.g., country, province, city, town, etc.). When visiting Chicago region 210, VPN client 212 would naturally be expected to login to VPN server 211. This need not be the case, however. VPN client 212 could instead choose to login to VPN server 221, which is located in San Francisco region 220. This choice could be motivated, for example, by the time of day in which the login occurred as it relates to the state of IT resources in the VPN. The connection from VPN client 212 to VPN server 221 is illustrated by network connection 230.

As would be appreciated, this choice of VPN server at login introduces location uncertainty into the process as any subsequent server that keys off of an assigned IP address or other indicator of location that is generated upon login to VPN server 221 can consider the user's location to be San Francisco region 220 instead of Chicago region 210. The difference in regions could, of course, represent distinct international regions. While the uncertainty in location can be valuable from the perspective of the anonymity provided to a personal VPN, the location uncertainty produces a costly uncertainty when considering the management or the provision of services to those VPN clients.

For example, a user in a foreign country that logs into a VPN server in the US, could be given access to information or services that would be restricted from that foreign country. As the corporate VPN would consider the user's location to be proximate to the particular US VPN server, no restriction would be placed on the information or services to which the VPN client could access. One example of such an access restriction would relate to content, which could be inside or outside of the private network. For example, public content restrictions could relate to the distribution of content such as the download of movies, web page access, etc. that are otherwise restricted by region for commercial or other reasons. Restricted private content examples can include certain assets that can only be accessed when the user is on a secure physical connection in the private network, not a VPN due to the risk of hacking or other compromise of data.

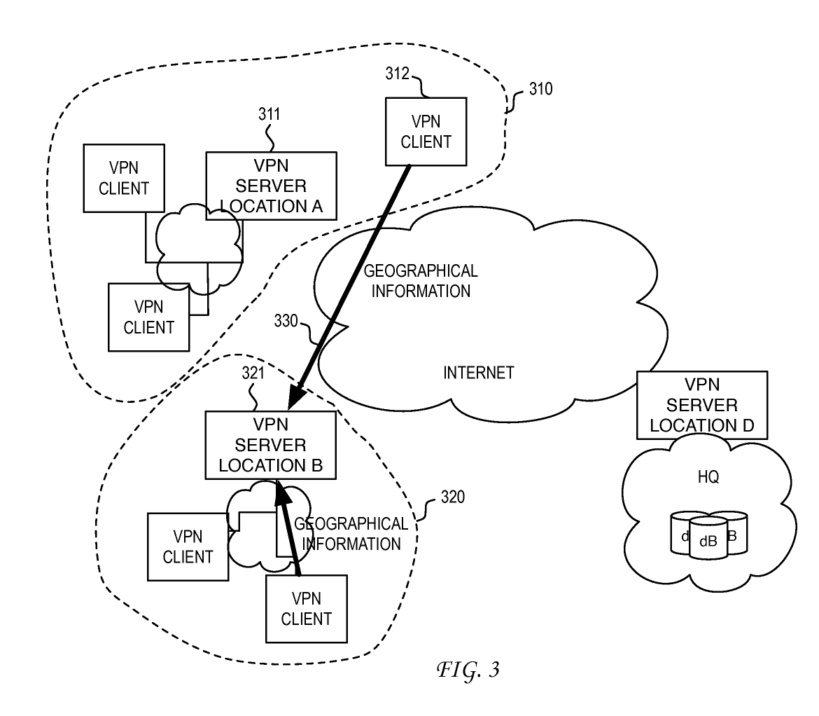

It is therefore a feature of the present invention that a location-assisted VPN is provided. This location-assisted VPN is designed to remove the location uncertainty that is introduced by the user freedoms during login. FIG. 3 illustrates an example of such a location-assisted VPN. As illustrated, VPN client 312 is visiting region 310, which includes VPN server 311. Instead of logging into VPN server 311, VPN client 312 chooses to login to VPN server 321 in region 320. To resolve the location uncertainty that is introduced by login by VPN client 312 to a VPN server in another region, VPN client 312 is also configured to send geographical information to VPN server 321 using network link 330. This geographical information is designed to provide an indication of the location of VPN client 312 in region 310 instead of a presumed location in region 320. As FIG. 3 further illustrates, a VPN client that logs into a VPN server in the region that the user is located can also be configured to send geographical information to the VPN server.

In one embodiment, the geographical information is generated by a GPS-enabled device such as a mobile phone, a login token, a computing device, or the like. While the GPS-generated geographical information can provide an accurate assessment of the location of VPN client 312, such accuracy may not be needed by the particular future access that is dependent on such geographical information. What may be more useful in some applications is the reliance on device-generated geographical information, which can be designed to remove some of the elements of fraud that can be introduced into the process by various users that seeks to subvert the location-assisted VPN process.

In one embodiment, the geographical information can be sent transparently to the VPN technology so it is passed as data over the VPN connection to the local server in the data center that can monitor user logins. In another embodiment, different profiles can be defined for a VPN client such that one of the profiles is activated at the login process once the geographic information is received. These different profiles can define different access restrictions/permissions to various classes of information/assets or to specific items of information/assets.

As would be appreciated, the specific mechanism by which device-generated geographical information is generated and reported to the VPN server during login would be implementation dependent. In one embodiment, the device-generated geographical information would be automatically provided by VPN client 312 to VPN server 321. In another embodiment, the device-generated geographical information would be keyed-in by the user during the login process. Here, the keyed-in geographical information can be properly encoded such that a verification of the encoded geographical information could detect fraudulent input by the user.

In another embodiment, the geographical information need not be device-generated. In this embodiment, the geographical information can be generated and input by the user. For example, the user can input the city or other geographical designation in which he is located during the login process. This self-generated geographical information may be enough for those applications in which the user's recorded positive assertion of an actual geographical location can be considered sufficient from an integrity perspective. In one embodiment, a analysis of the link hops between the VPN client and the VPN server can be performed, wherein such tracing of the link low level is invisible to the application and provides an enhancement to the VPN technology, hardware and software.

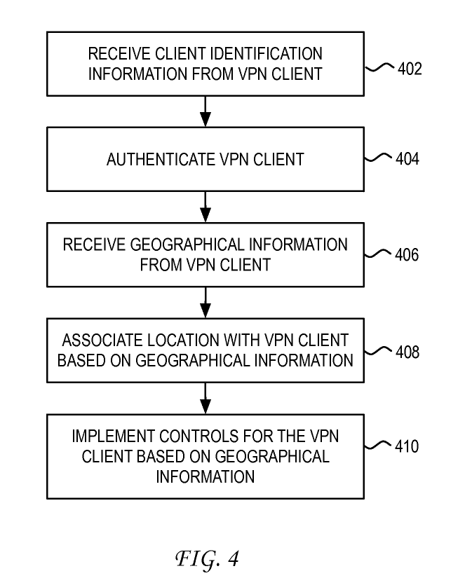

To further illustrate the features of the present invention, reference is now made to the flowchart of FIG. 4. As illustrated, the process of the present invention begins at step 402 where a VPN server receives client identification information from a VPN client for authentication. This client identification information can come in a variety of forms. In one example, the client identification information can be based on a hardware token (e.g., smart card) or digital certificate. These forms of identification information can enable a strong level of authentication. In other examples, a weaker level of authentication can be enabled through password identification information. Various encryption algorithms can also be used in the generation and transmission of identification information. As would be appreciated, the specific form of identification information used can be based on various factors such as security, cost, maintenance, etc.

Upon receipt of the identification information, the VPN server can then authenticate the VPN client at step 404. The authentication of the VPN client represents a primary condition to access of the VPN. In one embodiment, the geographical information provided by the VPN client can also represent a form of identification information used in the authentication process. For example, the VPN server can condition the entirety of access to the VPN not only on the basis of identity, but also on the basis of geographical information. This is useful where the VPN server is designed to only service VPN clients that actually reside in the geographical region supported.

More generally, however, geographical information can be used in the management or provision of services to the VPN client subsequent to the authentication for initial access to the VPN. As illustrated in FIG. 4, the geographical information is received from the VPN client at step 406. While the inclusion of this step is subsequent to the receipt of client identification information at step 402, it need not be so in actual implementation. In general, the geographical information can be received before, after or along with the identification information. All or part of the geographical information can also be integrated with the identification information.

After the geographical information is received by the VPN server, the VPN server then associates, at step 408, a location with the VPN client based on the geographical information. The association of step 408 can be embodied in various ways, the intent of which is to enable accurate location tracking of the VPN client. In one example, the VPN server assigns an IP address that is associated with a domain of another VPN server that serves a region indicated by the geographical information. In another example, the VPN server can designate a location indicated by the geographical information in a database record or other profile that can be accessed for operations, administration, maintenance, and provisioning purposes.

Based on such an association, the enterprise can then implement one or more controls for the VPN client based on such a location indication. As would be appreciated, the specific nature by which the location indication is used as a basis for one or more controls would be implementation dependent.

In one example, the location indication can be used as a condition for applications or other services that are made available to the VPN client. In another example, the location indication can be used as a condition for access to various databases or other data that can be accessed via the VPN. In another example, the location indication can be used as a condition for certain security or tracking measures (e.g., access levels) that are applied to the VPN client. In yet another example, the location indication can be used in association with other corporate policy or personal profile data in implementing some form of operations, administration, maintenance, and provisioning. Various alerts can also be triggered based on the indicated location associated with a VPN client.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A virtual private network method, comprising:
receiving, from a virtual private network client via an electronic communication network, client identification information at a virtual private network server, said virtual private network server being associated with a first location;
authenticating said virtual private network client based on an analysis of said received client identification information;
receiving, from said virtual private network client via said electronic communication network, geographical information at said virtual private network server, said geographical information being generated by a device associated with said virtual private network client; and
associating said virtual private network client with a second location that is derived from said received geographical information, said second location being geographically distant from said first location.

2. The method of claim 1, wherein said client identification information is hardware token information.

3. The method of claim 1, wherein said client identification information is digital certificate information.

4. The method of claim 1, wherein said client identification information is password information.

5. The method of claim 1, wherein said geographical information is based on GPS information.

6. The method of claim 1, wherein said geographical information is address information.

7. The method of claim 1, wherein said geographical information is generated by a device that produces said identification information.

8. The method of claim 1, wherein said second location is a location associated with a second virtual private network server.

9. The method of claim 1, wherein said associating comprises associating an IP address with said virtual private network client, said IP address being associated with a second virtual private network server.

10. A virtual private network method, comprising:
receiving, from a virtual private network client via an electronic communication network, geographical information at a first virtual private network server, said geographical information being generated by a device associated with said virtual private network client; and
associating said virtual private network client with a second location that is derived from said received geographical information, said second location being closer to a second virtual private network server different from said first virtual private network server.

11. The method of claim 10, wherein said geographical information is based on GPS information.

12. The method of claim 10, wherein said geographical information is based on address information.

13. The method of claim 10, wherein said associating comprises assigning an IP address associated with said second virtual private network server.

14. The method of claim 10, wherein said associating comprises associating a geographic position based on said location information with a session of said virtual private network client.

15. A virtual private network method, comprising
receiving, from a virtual private network client via an electronic communication network, geographical information at a first virtual private network server, said geographical information being closer to a second virtual private network server that is remote to said first virtual private network server; and
controlling one or more services provided to said virtual private network client through said first virtual private network server based on said received geographical information.

16. The method of claim 15, wherein said geographical information is based on GPS information.

17. The method of claim 15, wherein said geographical information is address information provided by a user of said virtual private network client.

18. The method of claim 15, wherein said controlling comprises restricting access to said one or more services.

19. The method of claim 15, wherein said controlling comprises providing an indication of a geographical position based on said received geographical information to said one or more services.

20. The method of claim 15, wherein said controlling comprises authorizing said one or more services based on an analysis of said received geographical information.
